(19) United States
(12) Patent Application Publication
(10) Pub. No.: US 2006/0001359 A1
(43) Pub. Date: Jan. 5, 2006

(54) Electron emission device and method for manufacturing the same

(76) Inventor: Seong-Yeon Hwang, Suwon-si (KR)

Correspondence Address: CHRISTIE, PARKER & HALE, LLP, PO BOX 7068, PASADENA, CA, 91109-7068, US

(21) Appl. No.: 11/173,067

(22) Filed: Jun. 30, 2005

(30) Foreign Application Priority Data
Jun. 30, 2004 (KR) 10-2004-0050586

(51) Int. Cl. H01J 1/62

(52) U.S. Cl. 313/495

(57) ABSTRACT

An electron emission device includes electron emission regions formed on a substrate, a plurality of driving electrodes for controlling the emission of electrons from the electron emission regions, and a focusing electrode placed at the same plane as any one of the driving electrodes while being spaced apart from the driving electrode with a predetermined distance. The focusing electrode partially has a thickness larger than the driving electrode. The focusing and the driving electrodes placed at the same plane are formed with line portions proceeding parallel to each other and a plurality of extensions extended from the line portions toward the opposites, and the extensions of the focusing electrode and the extensions of the driving electrode are alternately repeated in a direction of the substrate.

### CROSS REFERENCE TO RELATED APPLICATION

This application claims priority to and the benefit of Korean Patent Application No. 10-2004-0050586 filed on Jun. 30, 2004 in the Korean Intellectual Property Office, the entire content of which is incorporated herein by reference.

### FIELD OF THE INVENTION

The present invention relates to an electron emission device, and in particular, to an electron emission device which has an improved structure of a focusing electrode for focusing the electron beams, and a method of manufacturing the electron emission device.

### BACKGROUND

Generally, electron emission devices are classified into those using hot cathodes as the electron emission source, and those using cold cathodes as the electron emission source. There are several types of cold cathode electron emission devices, including a field emitter array (FEA) type, a metal-insulator-metal (MIM) type, a metal-insulator-semiconductor (MIS) type, and a surface conduction emitter (SCE) type.

Although the electron emission devices are differentiated in their specific structure depending upon their types, they basically have first and second substrates sealed to each other to form a vacuum vessel, an electron emission unit formed on the first substrate to emit electrons toward the second substrate, and a light emission unit formed on a surface of the second substrate facing the first substrate to emit visible rays due to the electrons.

The electron emission unit includes driving electrodes, and electron emission regions controlled by the driving electrodes. The light emission unit includes phosphor layers, and an anode electrode for accelerating the electrons emitted from the electron emission regions toward the phosphor layers.

When electrons are emitted from the electron emission regions to light-emit the phosphor layers, the electrons are liable to be diffused toward the pixels neighboring to the target pixel, therefore, deteriorating the screen color purity.

It has been proposed that a grid electrode or a focusing electrode should be placed on the routes of electron beams to control the electron beams. The grid electrode is formed with a metallic plate having a plurality of beam passage holes, and disposed between the first and the second substrates while being spaced apart from them with a predetermined distance using spacers. The focusing electrode is placed at the topmost area of the electron emission unit while being insulated from the driving electrodes by an insulating layer.

When the electron emission device has a grid electrode, spacers are mounted on the first substrate or the second substrate, and the grid electrode is disposed between the two substrates in conformity with the alignment state of the two substrates, followed by sealing the two substrates to each other to form a vacuum vessel. However, it is very difficult to conduct such a process, and the relevant processing steps are complicated.

When the electron emission device has a focusing electrode, as the height of the focusing electrode with respect to the electron emission regions is increased, the beam focusing effect is enhanced. However, when the thickness of the insulating layer for supporting the focusing electrode is enlarged, opening portions with a high aspect ratio (the ratio of the height to the width of the opening portion) should be formed at the insulating layer and the focusing electrode to pass the electron beams. Also, the formation of the opening portions involves complicated processing steps.

### SUMMARY OF THE INVENTION

In one exemplary embodiment of the present invention, there is provided an electron emission device which involves an improved structure of a focusing electrode placed on the routes of electron beams to highly exert the beam focusing effect, and a method of manufacturing the electron emission device with simplified processing steps.

In one exemplary embodiment of the present invention, the electron emission device includes an electron emission region formed on a substrate, a driving electrode for controlling the emission of electrons from the electron emission region, and a focusing electrode placed in the same plane as the driving electrode while being spaced from the driving electrode a predetermined distance. The focusing electrode partially has a thickness larger than the driving electrode. The focusing and the driving electrodes each have a line portion proceeding parallel to each other and a plurality of extensions extended away from the line portions toward each other, and the extensions of the focusing electrode and the extensions of the driving electrode are alternately repeated in a direction of the substrate.

The extensions of the driving electrode are located corresponding to the pixel regions defined on the line portions.

In another exemplary embodiment of the present invention, the electron emission device includes first and second substrates facing each other with a predetermined distance, cathode electrodes formed on the first substrate, and electron emission regions electrically connected to the cathode electrodes. Gate electrodes are formed over the cathode electrodes and the electron emission regions with an insulating layer formed between the gate electrodes and the cathode electrodes. Each gate electrode has a first line portion placed at a side of an array of pixel regions defined on the first substrate, and first extensions extended away from the first line portion and arranged at the respective pixel regions. Focusing electrodes are formed on the insulating layer. Each focusing electrode has a second line portion spaced apart from the ends of the first extensions with a predetermined distance while proceeding parallel to the first line portion, and second extensions extended from the second line portion toward the first line portion, each second extension being disposed between two adjacent first extensions. The focusing electrode partially has a thickness larger than the gate electrode.

The cathode electrode and the first line portion proceed perpendicular to each other, and the first extensions are overlapped with the cathode electrode.

The focusing electrode has a first layer with the same thickness as the gate electrode, and a second layer formed on the portions of the first layer corresponding to the second extensions with a thickness larger than the first layer.

Alternatively, the focusing electrode may have a first layer with the same thickness as the gate electrode, and a second layer formed on the first layer with a thickness larger than the first layer.

The distance between the gate electrode and the focusing electrode may be two or less times larger than the thickness of the second insulating layer.

In a method of manufacturing the electron emission device, cathode electrodes are first formed on a substrate. An insulating layer is formed on substantially the entire surface of the substrate such that the insulating layer covers the cathode electrodes. Gate electrodes and a first layer for focusing electrodes are formed by applying a conductive material onto the insulating layer, and patterning it. Gate holes are formed at the gate electrodes and the insulating layer such that the cathode electrodes are partially exposed. A second layer for the focusing electrodes is formed by applying a conductive material onto the first layer at predetermined locations thereof with a thickness larger than the thickness of the first layer. Electron emission regions are formed on the cathode electrodes within the gate holes.

The first layer for the focusing electrodes and the gate electrode may be formed by vacuum-depositing or sputtering a metallic material. The second layer for the focusing electrodes may be formed by screen-printing a conductive material, drying and firing it, or plating it.

### BRIEF DESCRIPTION OF THE DRAWINGS

The above and other advantages of the present invention will become more apparent by describing embodiments thereof in detail with reference to the accompanying drawings in which:

FIG. 1 is a partial exploded perspective view of an electron emission device according to an embodiment of the present invention;

FIG. 2 is a partial sectional view of the electron emission device shown in FIG. 1;

FIG. 3 is a partial plan view of the electron emission unit shown in FIG. 1;

FIG. 4 is a partial sectional perspective view of an electron emission device, illustrating a variant of the focusing electrode; and

FIGS. 5A to 5D schematically illustrate the steps of manufacturing the electron emission device according to one embodiment of the present invention.

### DETAILED DESCRIPTION

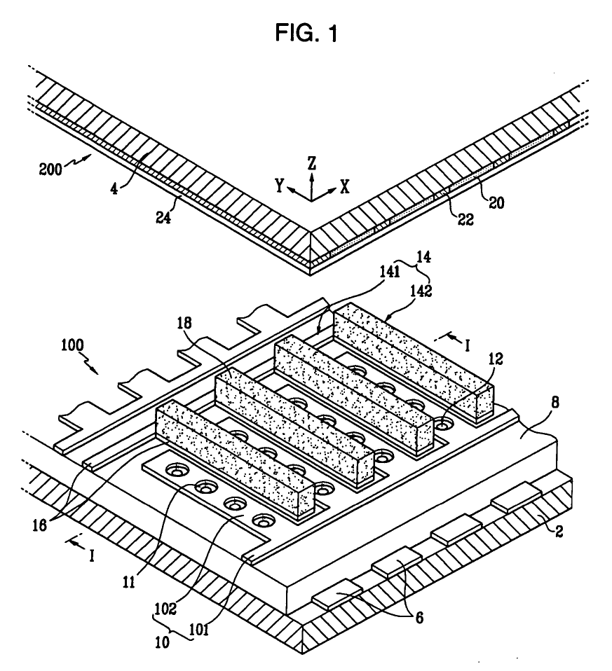

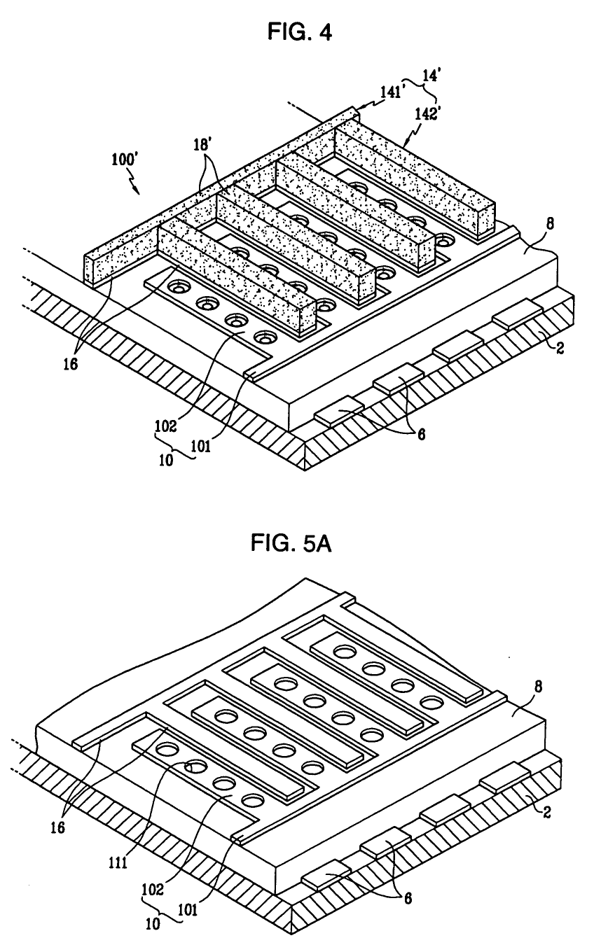

FIGS. 1 to 3 show different views of an electron emission device, avvording to one embodiment of the present invention. As shown in FIGS. 1 to 3, the electron emission device includes first and second substrates 2 and 4 arranged parallel to each other with a predetermined distance. A sealing member (not shown) is provided at the peripheries of the first and the second substrates 2 and 4, thereby forming a vacuum inner space in association with the first and the second substrates 2 and 4.

An electron emission unit 100 is provided on a surface of the first substrate 2 facing the second substrate 4 to emit electrons toward the second substrate 4. A light emission unit 200 is provided on a surface of the second substrate 4 facing the first substrate 2 to emit visible rays due to the electrons.

Cathode electrodes 6 are stripe-patterned on the first substrate 2 in a direction of the first substrate 2, and an insulating layer 8 is formed on the entire surface of the first substrate 2 while covering the cathode electrodes 6. A plurality of gate (driving) electrodes 10 are formed on the insulating layer 8 perpendicular to the cathode electrodes 6.

In this embodiment, when the crossed regions of the cathode and the gate electrodes 6 and 10 are defined as pixel regions, the gate electrodes 10 have a first line portion 101, and first extensions 102 extended from the first line portion 101 toward the respective pixel regions. That is, the gate electrodes 10 are formed with a first line portion 101 proceeding perpendicular to the cathode electrode 6, and first extensions 102 extended from the first line portion 101 along the cathode electrodes 6 and arranged at the respective pixel regions.

Gate holes 11 are formed at the first extensions 102 and the insulating layer 8 placed under the first extensions 102 while partially exposing the cathode electrodes 6. Electron emission regions 12 are formed on the cathode electrodes 6 within the gate holes 11.

In this embodiment, the electron emission regions 12 are formed with a material emitting electrons under the application of an electric field, such as a carbonaceous material, and a nanometer-sized material. The electron emission regions 12 may be formed with carbon nanotube, graphite, graphite nanofiber, diamond, diamond-like carbon, C₆₀, silicon nanowire or a combination thereof, by way of screen-printing, direct growth, chemical vapor deposition, or sputtering.

As illustrated in FIGS. 1 to 3, four gate holes 11 and electron emission regions 12 are formed at the respective pixel regions in the direction of the cathode electrodes 6, and the gate holes 11 and the electron emission regions 12 have a circular plane shape. However, the number and shape of the gate holes 11 and the electron emission regions 12 are not so limited, but may be altered in various manners.

A focusing electrode 14 is formed on the insulating layer 8 while being spaced apart from the gate electrodes 10 with a distance. A portion of the focusing electrode 14 has a thickness larger than the gate electrodes 10. In this embodiment, the focusing electrode 14 is placed in the same plane as the gate electrodes 10, and partially has a thickness larger than the gate electrodes 10 to fluently focus the electron beams.

Specifically, the focusing electrode 14 has a second line portion 141 spaced apart from the ends of the first extensions 102 with a distance while crossing the cathode electrodes 6, and second extensions 142 extended from the second line portion 141 toward the first line portion 101 and disposed between the first extensions 102. The first and the second extensions 102 and 142 are alternately repeated along the length of the first and the second line portions 101 and 141.

Particularly, the focusing electrode 14 is formed with a double-layered structure having a first layer 16 formed with the same thickness as the gate electrodes 10, and a second layer 18 formed on the first layer 16 with a thickness larger than that of the first layer 16. The first layer 16 may be formed simultaneously with the gate electrodes 10 based on the same conductive material as the gate electrodes 10. The second layer 18 highly surrounds the routes of electron beams due to its own height, and is partially formed on the first layer 16.

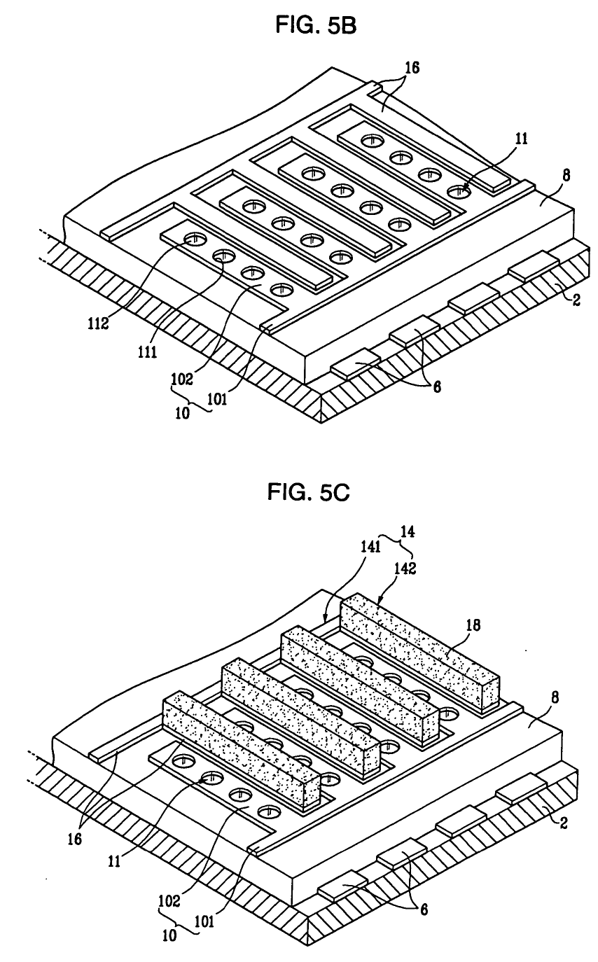

The second layer 18 is provided at the second extension 142 while proceeding parallel to the cathode electrode 6. Alternatively, as shown in FIG. 4, the second layer 18′ may be provided at both the second line portion 141′ and the second extension 142′ while proceeding parallel to the cathode electrode 6 at the second extension 142′, as well as perpendicular to the cathode electrode 6 at the second line portion 141′.

In the former case, the second layers 18 are provided at the left and the right sides of the electron emission regions 12, and when electrons are emitted from the electron emission regions 12, they are placed at the left and the right sides of the route of the electron beams to serve to focus the electron beams. In the latter case, the second layers 18′ are placed at the left and the right sides of the route of the electron beams as well as at the top thereof to serve to focus the electron beams, thereby preventing the beam spreading.

The second layers 18 and 18′ may be formed through thick filming such as screen printing, or plating such that it has a thickness of about 3-20 μm.

In order to focus the electron beams using the above-structured focusing electrode 14, a negative (−) voltage is applied to the focusing electrode 14. In case the focusing electrode 14 is thin, the same focusing effect can be exerted only when higher voltage is applied thereto. By contrast, in case the focusing electrode 14 is thick, the same focusing effect can be exerted even though the voltage applied to the focusing electrode 14 is lowered. In the latter case, however, the thickness enlargement of the focusing electrode 14 is limited due to the processing factor.

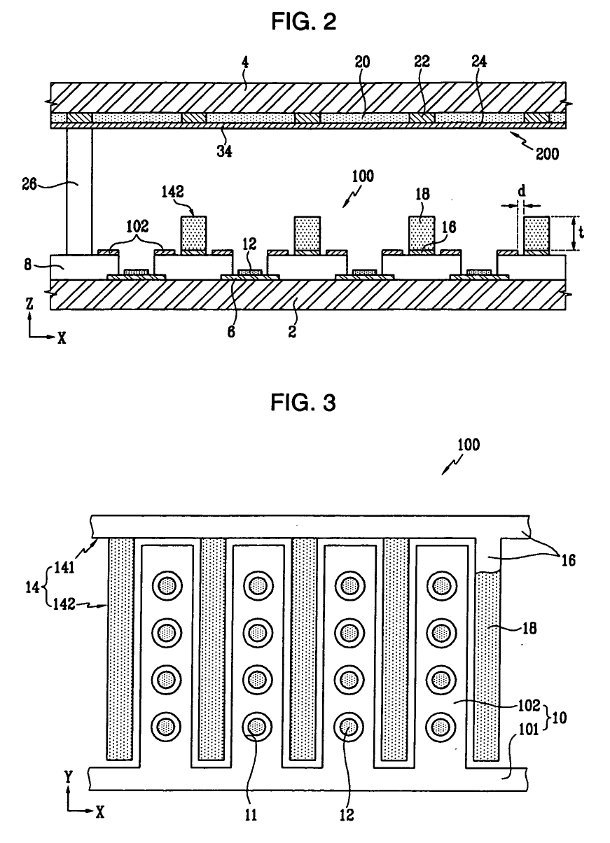

For this reason, a negative (−) voltage of several ten volts or less is applied to the focusing electrode 14, and the thickness of the focusing electrode 14 is controlled to achieve the desired object. The voltage applied to the focusing electrode 14 is in proportion to the distance d (shown in FIG. 2) between the corresponding gate and the focusing electrodes 10 and 14, and inversely proportion to the thickness of the corresponding focusing electrode 14. That is, the inter-electrodes distance d and the thickness of each of the focusing electrodes 14 are reciprocally compensated for each other.

In this connection, the distance d between a focusing electrode 14 and the corresponding gate (driving) electrode 10 is established to be two or less times larger than the thickness t of the second layer 18, shown in FIG. 2, and in this case, the desired beam focusing effect can be exerted when a negative (−) voltage of several tens volts or less is applied to the focusing electrode 14.

Red, green and blue phosphor layers 20 are formed on a surface of the second substrate 4 facing the first substrate 2 while being spaced apart from each other with a distance, and black layers 22 are formed between the phosphor layers 20 to enhance the screen contrast. An anode electrode 24 is formed on the phosphor layers 20 and the black layers 22 with a metallic material, such as aluminum.

The anode electrode 24 receives a high voltage required for accelerating electron beams from the outside, and reflects the visible rays radiated from the phosphor layers 20 to the first substrate 2 toward the second substrate 4 to heighten the screen luminance. Alternatively, the anode electrode 24 may be formed with a transparent conductive material, such as indium tin oxide (ITO). In this case, the anode electrode 24 is placed on a surface of the phosphor layers 20 and the black layers 22 facing the second substrate 4.

Spacers 26 are arranged between the first and the second substrates 2 and 4 to maintain the distance between the two substrates constantly, and to support the substrates while preventing the distortion and breakage thereof. For convenience, only one spacer is illustrated in FIG. 2.

With the above-structured electron emission device, when predetermined driving voltages are applied to the cathode and the gate electrodes 6 and 10, electric fields are formed around the electron emission regions 12 due to the voltage difference between the two electrodes, and electrons are emitted from the electron emission regions 12. The emitted electrons are focused by the voltage applied to the focusing electrode 14, for instance, a negative (−) voltage of several volts to several ten volts, and involve further straightness. The electrons are attracted by the high voltage applied to the anode electrode 24, and directed toward the second substrate 4, thereby colliding against the phosphor layers 20 at the relevant pixels and light-emitting them.

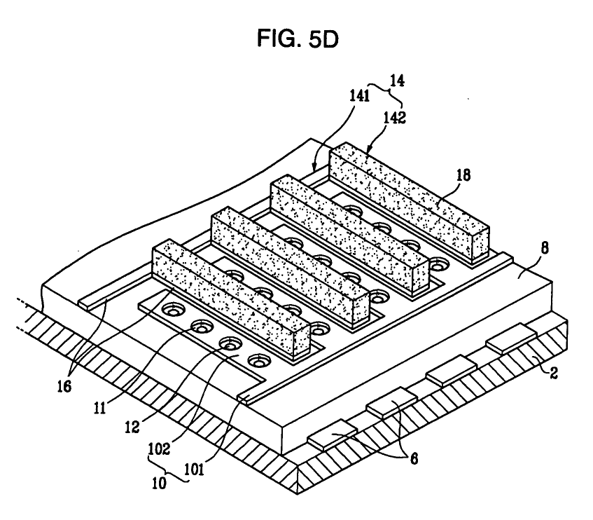

A method of manufacturing an electron emission device according to the embodiment of the present invention will be now explained with reference to FIGS. 5A to 5D.

As shown in FIG. 5A, a conductive material is applied onto a first substrate 2, and patterned to thereby form cathode electrodes 6. An insulating material is deposited onto the entire surface of the first substrate 2 while covering the cathode electrodes 6 to thereby form an insulating layer 8. Thereafter, a conductive material is again applied onto the insulating layer 8, and patterned to simultaneously form gate (driving) electrodes 10 with first gate holes 111, and a first layer 16 for a focusing electrode.

The gate electrodes 10 and the first layer 16 are formed with a metallic material, such as chromium Cr, aluminum Al, or molybdenum Mo by way of vacuum deposition or sputtering such that they have a thickness of several thousands angstroms (Å). The distance d between each of the gate electrodes 10 and the first layer 16 is established to be two or less times larger than the thickness of a second layer to be formed later.

As shown in FIG. 5B, the insulating layer 8 is partially etched to form second gate holes 112 below the first gate holes 111 such that they are communicated with the first gate holes 111. In this way, gate holes 11 are formed at the locations to be formed with electron emission regions such that the cathode electrodes 6 are partially exposed.

As shown in FIG. 5C, a second layer 18 is partially or wholly formed on the first layer 16 with a thickness of about 3-20 μm, thereby forming a focusing electrode 14. It is illustrated in the drawing that the second layer 18 is partially formed on the first layer 16.

The second layer 18 may be formed by selectively printing a conductive material on the first layer 16 at predetermined portions thereof, drying and firing it. Alternatively, the second layer 18 may be formed by printing a photosensitive conductive material onto the entire surface of the first substrate 2, partially hardening the photosensitive conductive material by light-exposing it, removing the non-hardened conductive material by developing it, and drying and firing the hardened conductive material.

As shown in FIG. 5D, electron emission regions 12 are formed on the cathode electrodes 6 within the gate holes 11 to thereby complete an electron emission unit 100. The electron emission regions 12 may be formed through preparing a paste-phased electron emission material, partially or wholly printing and patterning it, and drying and firing it. The formation of the electron emission regions 12 may be made through direct growth, sputtering or deposition.

With the inventive method of manufacturing the electron emission device, a focusing electrode 14 can be easily structured such that it is spaced apart from a corresponding gate electrode 10 with a predetermined distance, and partially has a thickness larger than the corresponding gate electrode 10.

As described above, with the electron emission device according to the present invention, the above-structured focusing electrode is formed on the insulating layer so that the beam focusing efficiency is heightened with simplified processing steps. Accordingly, the inventive electron emission device involves enhanced screen color purity with a high screen image quality.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An electron emission device comprising:
an electron emission region formed on a substrate;
a driving electrode for controlling the emission of electrons from the electron emission region; and
a focusing electrode placed in a same plane as the driving electrode while being spaced from the driving electrode a predetermined distance, the focusing electrode partially having a thickness larger than the driving electrode;
wherein the focusing electrode and the driving electrode each have a line portion proceeding parallel to each other and a plurality of extensions extended away from the line portions toward each other, and the extensions of the focusing electrode and the extensions of the driving electrode are alternately repeated in a direction of the line portions.

2. The electron emission device of claim 1, wherein the extensions of the driving electrode are located corresponding to a plurality of pixel regions defined on the substrate.

3. The electron emission device of claim 1, wherein the focusing electrode comprises a first layer formed with the same thickness as that of the driving electrode, and a second layer formed on the portions of the first layer corresponding to the extensions with a thickness larger than the first layer.

4. The electron emission device of claim 1, wherein the focusing electrode has a first layer with the same thickness as the driving electrode, and a second layer formed on the first layer with a thickness larger than the first layer.

5. An electron emission device comprising:
first and second substrates facing each other with a predetermined distance;
cathode electrodes formed on the first substrate;
electron emission regions electrically connected to the cathode electrodes;
gate electrodes formed over the cathode electrodes and the electron emission regions with an insulating layer formed between the gate electrodes and the cathode electrodes, each gate electrode having a first line portion placed at a side of an array of pixel regions defined on the first substrate parallel to the array, and first extensions extended away from the first line portion and arranged at the respective pixel regions; and
focusing electrodes formed on the insulating layer, each focusing electrode having a second line portion spaced apart from the ends of the first extensions with a predetermined distance while proceeding parallel to the first line portion, and second extensions extended from the second line portion toward the first line portion, each second extension being disposed between two adjacent first extensions, the focusing electrode partially having a thickness larger than the gate electrode.

6. The electron emission device of claim 5, wherein the cathode electrode and the first line portion proceed perpendicular to each other, and the first extensions are overlapped with the cathode electrode.

7. The electron emission device of claim 5, wherein the focusing electrode has a first layer with the same thickness as the gate electrode, and a second layer formed on the portions of the first layer corresponding to the second extensions with a thickness larger than the first layer.

8. The electron emission device of claim 7, wherein the distance between the gate electrode and the focusing electrode is two or less times larger than the thickness of the second layer.

9. The electron emission device of claim 5, wherein the focusing electrode has a first layer with the same thickness as the gate electrode, and a second layer formed on the first layer with a thickness larger than the first layer.

10. The electron emission device of claim 9, wherein the distance between the gate electrode and the focusing electrode is two or less times larger than the thickness of the second layer.

11. The electron emission device of claim 5, wherein the electron emission regions are formed with at least one material selected from the group consisting of carbon nanotube, graphite, graphite nanofiber, diamond, diamond-like carbon, C₆₀, and silicon nanowire.

12. A method of manufacturing an electron emission device, the method comprising:
forming cathode electrodes on a substrate;
forming an insulating layer on substantially the entire surface of the substrate such that the insulating layer covers the cathode electrodes;
forming gate electrodes and a first layer for focusing electrodes by applying a conductive material onto the insulating layer and patterning the conductive material;
forming gate holes at the gate electrodes and the insulating layer such that the cathode electrodes are partially exposed;
forming a second layer for the focusing electrodes by applying a conductive material onto the first layer at predetermined locations thereof with a thickness larger than a thickness of the first layer; and
forming electron emission regions on the cathode electrodes within the gate holes.

13. The method of claim 12, wherein with the applying a conductive material onto the insulting layer, a metallic material is vacuum-deposited or sputtered.

14. The method of claim 12, wherein with the forming a second layer for the focusing electrodes, the conductive material is screen-printed, dried, and fired.
